(19) United States
(12) Patent Application Publication
(10) Pub. No.: US 2004/0019526 A1
(43) Pub. Date: Jan. 29, 2004

(54) Ordering terminal, order management system and ordering method

(75) Inventor: Masanori Takeuchi, Shizuoka-ken (JP)

Correspondence Address: PILLSBURY WINTHROP, LLP, P.O. BOX 10500, MCLEAN, VA, 22102, US

(73) Assignee: Toshiba TEC Kabushiki Kaisha, Tokyo (JP)

(21) Appl. No.: 10/449,691

(22) Filed: Jun. 2, 2003

(30) Foreign Application Priority Data
Jun. 4, 2002 (JP) 2002-162540

(51) Int. Cl. G06F 17/60

(52) U.S. Cl. 705/15

(57) ABSTRACT

Information relating to an order for a menu item displayed on a menu table that is held in a menu table holding part can be transmitted to an order management apparatus by simply operating a direct key with which the aforesaid order information has previously been made to associate. In addition, by making information relating to an order for each of menu items that are frequently ordered or store-recommended to associate with the direct-key, an effect of sales promotion can be expected.

### BACKGROUND OF THE INVENTION

1. Field of the Invention

The present invention relates to an ordering terminal, order management system, and ordering method, which are used in, for example, eating establishments.

2. Description of Related Art

Today, an order entry system as an order management system that conveys an order from a customer to, a cook in a restaurant or the like comprises, so as to be freely communicable to each other, a number of handy terminals that store attendants individually carry, a predetermined number of kitchen printers installed in a cooking place, a POS (point of sales) terminal as an accounting machine installed at a cashier desk, and a control station as an order management apparatus that controls the whole system. To be more specific, the handy terminal is designed to input at least customer information and order information using a keyboard provided therein. The kitchen printer is made to print on continuous forms order data produced according to various information.

In such an order entry system, a store attendant inputs order information and supplemental note received from a customer using the keyboard of the handy terminal. The order data is produced based on this inputted information and other related information, and radio-transmitted to the control station. The order data is also transmitted to the kitchen printer. The kitchen printer then forms a cooking instruction slip according to the order data received. By following this cooking instruction slip, a cook can prepare cooking promptly and positively.

Under deflationary depression today, eating establishments are demanded for improvement in operational efficiency and reduction of personnel expense has become an urgent task.

Recently, in order to reduce workloads of a store attendant a self-ordering terminal is provided on each table so that a customer can place an order by himself/herself, as described in Japanese (KOKAI) Publication No. 8-335294.

More specifically, a store provides a menu table on which order numbers associated with respective menu items to be ordered are indicated and a wireless terminal (self-ordering terminal) at each table. A customer enters an order number corresponding to a menu item that he or she wishes to order into a wireless terminal provided on each table. When all the order entries are completed, a customer presses an end key of the wireless terminal so that order information of the selected menu items is transmitted to accounting facility and a cooking place.

In this manner, a customer can place an order by entering an order number to a wireless terminal viewing a menu table on which order numbers are indicated.

According to such a self-ordering terminal, orders can be placed by customers themselves, and thereby, store attendants need not go to customers to ask for orders. Their work efficiency can be thus improved.

However, such convenient self-ordering terminals involve some problems: first, entry operations are troublesome and order errors tend to occur because convenient self ordering terminals require inputting numbers (order numbers) for all orders; secondly, those terminals offer no effect for promoting sales of merchandise.

### SUMMARY OF THE INVENTION

An object of the present invention is to provide an ordering terminal, order management system, and ordering method that can prevent order errors when a customer orders by himself/herself.

Another object of the invention is to provide an ordering terminal, order management system, and ordering method that can expect an effect of sales promotion of merchandise.

To achieve the above-mentioned objects, the ordering terminal comprises a direct key that has been previously made to associate with information regarding an order of a menu item, a display section that displays information regarding the order of the menu item when the aforesaid direct key is operated, an order transmission section that transmits to an order management apparatus information regarding the order of the menu item for which the aforesaid direct key has been operated, and a menu table holding section that holds a menu table displaying the menu item that associates with the aforesaid direct key.

### BRIEF DESCRIPTION OF THE DRAWINGS

FIG. 1 shows a system structure of a whole system of an order entry system according to an embodiment of the present invention.

FIG. 2 is a prospective view that generally shows a table-top ordering terminal.

FIG. 3 is a side view of the above terminal.

FIG. 4 is a front view of various operation keys.

FIG. 5 is a block diagram indicating electrical connections among internal sections within the table-top ordering terminal.

FIG. 6 is a flow chart exhibiting a flow of key entry processing.

FIG. 7 is an illustration of an exemplified screen displayed on entry of a ten-key.

FIG. 8 is an illustration of an exemplified screen displayed on entry of a number-order key.

FIG. 9 is an illustration of an exemplified screen displayed on entry of a charge-confirmation key.

FIG. 10 is an illustration of an exemplified screen displayed on entry of an order-confirmation key.

FIG. 11 is an illustration of an exemplified screen displayed on entry of a direct key.

FIG. 12 is a block diagram indicating electrical connections among internal sections within the handy terminal.

FIG. 13 is a block diagram indicating electrical connections among internal sections within the control station.

FIG. 14 shows a data structure in a customer order information file.

FIG. 15 shows a content of the terminal designation table.

FIG. 16 is a flow chart displaying operations of the order entry system.

### DETAILED DESCRIPTION OF A PREFERRED EMBODIMENT OF THE INVENTION

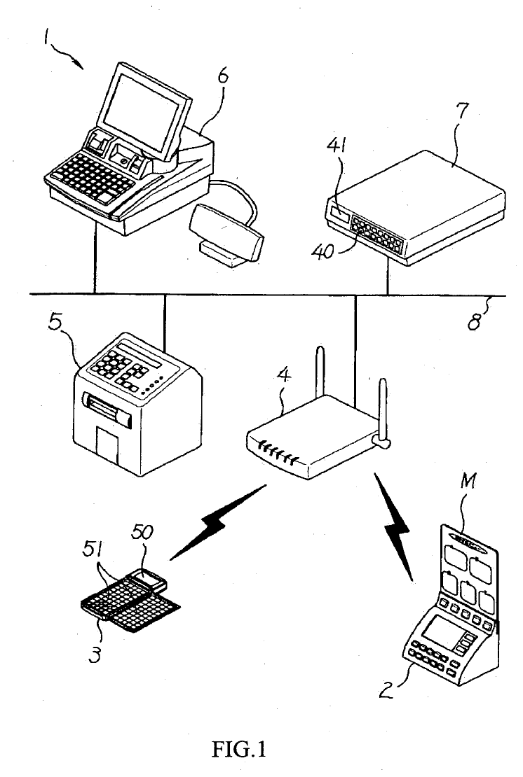

One embodiment according to the present invention will be explained in reference to FIGS. 1 through 16.

This embodiment is applied to, for example, an order entry system as an order management system used in eating establishments such as a restaurant. The whole system is constituted as shown in FIG. 1. This order entry system 1 comprises: a handy terminal 3 that the store employees carry individually; a wireless communication unit 4 that is installed on ceiling or the like to enable wireless communications with the handy terminals 3; a kitchen printer 5 that prints and issues a cooking instruction slip (not shown) that instructs a cook for a menu item that has been ordered; a POS (Point of Sales) terminal 6 as an accounting machine that is installed on a cashier desk; a control station 7 as the order management that controls the whole system. The afore-mentioned order entry system 1 is structured such that the control station 7 is connected via the communication lines 8 to the wireless communication system 4, the kitchen printer 5, and the POS terminal 6. The respective numbers of the wireless communication system 4 and the kitchen printer 5 to be used are at user's option.

In addition, in this order entry system 1, there is provided with the table-top ordering terminal 2, which is a feature of this embodiment. This table-top ordering terminal 2, details of which is to be given later, is designed to be operable being placed on each table so that an order can be made by a customer himself/herself. It also can perform wireless communications with the wireless communication system 4 as the handy terminal 3 does.

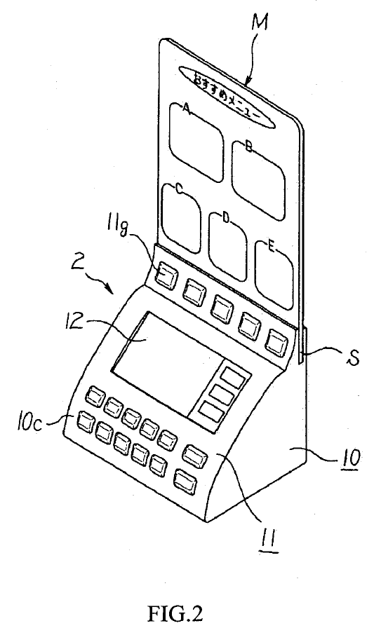

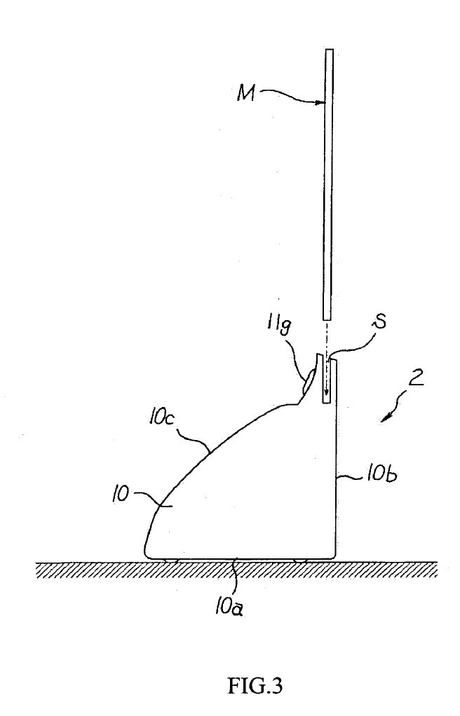

Now, the table-top ordering terminal 2 will be detailed. FIG. 2 is a general perspective view of the table-top ordering terminal 2, and FIG. 3 is its side view. The housing of the table-top ordering terminal 2 is nearly fan-shaped in its longitudinal section, its base 10a that is placed on a table and rear 10b thereof form nearly a right angle. In the upper part of the housing, a slit S is formed as a groove constituting the menu table holding section. This slit S removably holds the menu table M with the menu table inserted into the slit, the menu table M displaying menu items on a table in a visually distinguishable manner. The menu table M is, for example, a printed matter in a sheet made of a paper or plastic. Provided on a front surface 10C of the housing 10 are various operation keys 11 and a LCD (liquid crystal display) 12 as a display section for displaying order contents and prices.

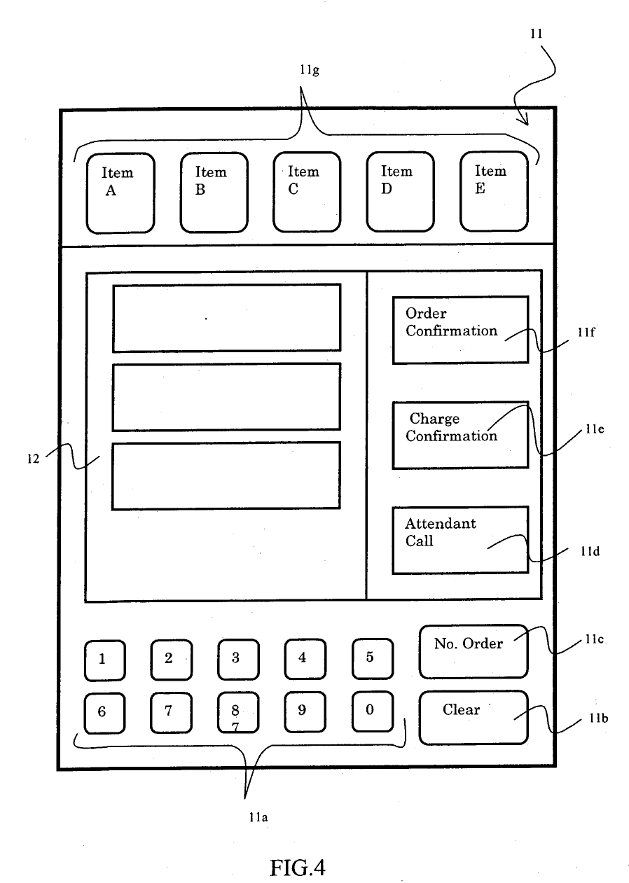

Herein, the various operation keys 11 provided on the front surface 10C of the housing 10 will be explained in conjunction with FIG. 4. The operation keys include ten-keys 11a for entering numerals from “0” through “9,” a clear key 11b for clearing numerals entered by the ten-keys 11a, a number-order key 11c that declares an order with registration of a item number by the numeral entry using the ten-keys 11a, an attendant-call key 11d for calling a store attendant, an amount-confirmation key 11e for confirming a current charge amount for orders placed by then, an order-confirmation key 11f for confirming current orders that have been made by then, and five direct-keys 11g, to each of which is preset information relating to an order for a menu item that is frequently ordered or recommended by a store.

In this embodiment of the table-top ordering terminal 2, there are provided five direct keys 11g that are related to five menu items printed on the menu table M that is inserted in the slit S. The number of the direct keys 11g need not be limited to five. The direct keys 11g are arranged in the vicinity of the slit S into which the menu table M is inserted. This is because by such an arrangement it can be distinctly seen that each of the five menu items printed on the menu table M inserted in the slit S relates to respective one of the five direct keys. In such a fashion, if recommended menu items are printed on the menu table M, a significant sales promotion can also be expected.

Further, if frequently ordered menu items are printed on the menu table M, occurrence of miss-ordering can be positively prevented, and thereby efficiency at work can be dramatically improved.

Also, because the menu table M held in the table-top ordering terminal 2 is a printed material made of a paper or plastic sheet, the contents of the menu items can be easily revised. In such a case, only order-related information associated with (preset to) five direct keys 11g is to be changed accordingly.

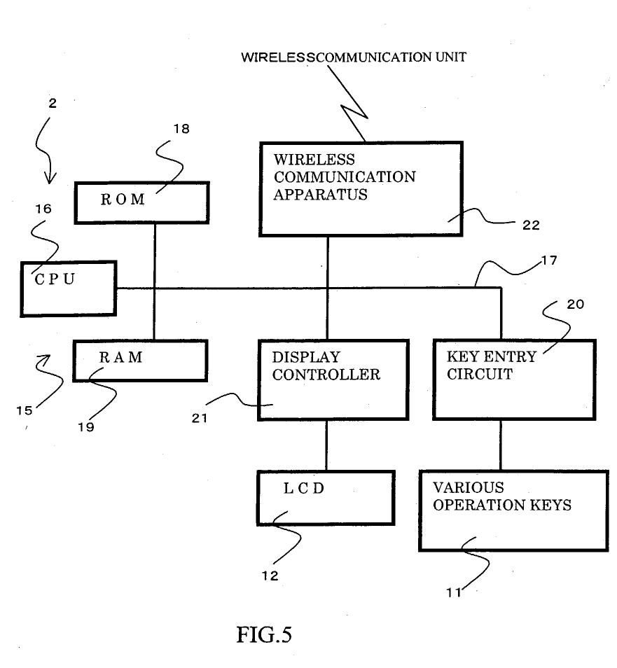

Now, electrical connections among the respective sections within the table-top ordering terminal 2 will be explained below in conjunction with FIG. 5. As shown in the FIGURE, the table-top ordering terminal 2 is provided with a microcomputer 15, which controls each of the sections. The microcomputer 15 is structured such that a ROM (Read Only Memory) 18 that has previously stored control programs for operating a CPU (Central Processing Unit) 16 and fixed data, and a RAM (Random Access Memory) 19 that functions as a work-area memory in which various data are freely rewritten are connected via a bus 17 to the CPU 16, which centrally controls each of the sections. The ROM 18 also contains a merchandise master file (not shown) that retains names of various menu items and prices related to the menu items.

Connected to this microcomputer 15 are various keys through the key entry circuit 20 and the LCD 12 through the display controller 21. The table-top ordering terminal 2 is also provided with a wireless communication apparatus 22, which is also connected to the microcomputer 15 via the bus 17, for radio-communicating with the wireless communication system 4. This enables the table-top ordering terminal 2 to perform data transmission and reception from/to the control station 7.

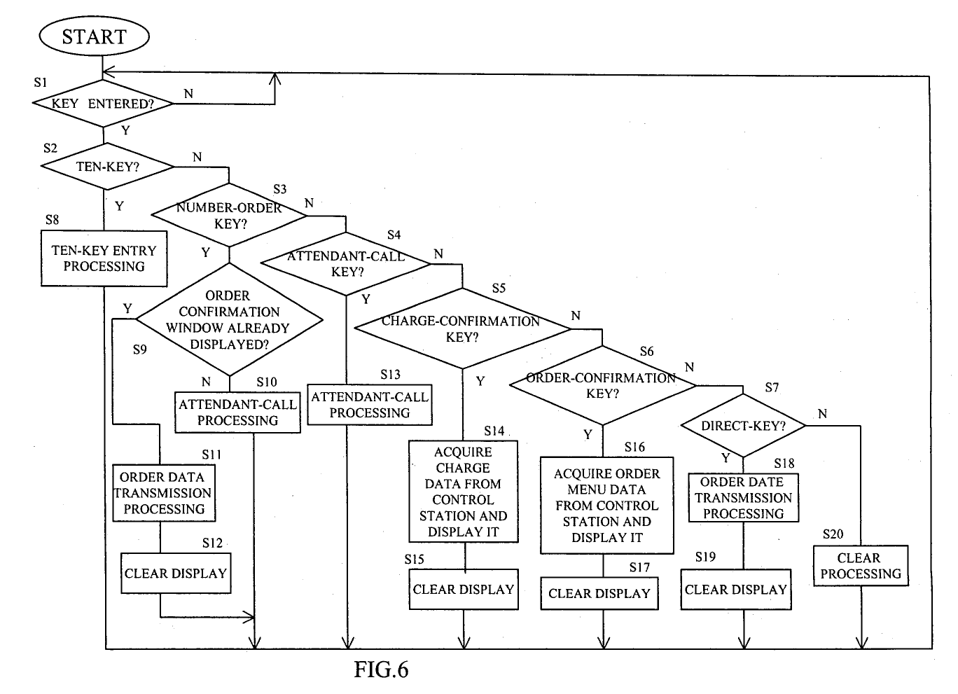

Next, operations will be described that the microcomputer 15 executes according to the control programs stored in the ROM 18 within the table-top ordering terminal 2. FIG. 6 is a flow chart that generally displays a flow of key entry processing. As shown in the FIGURE, when key entering occurs by operating any of the operation keys 11 within the table-top ordering terminal 2 (Y in step S1), it is judged in steps S2 through S7 as to which key among the ten-keys 11a, the clear key 11b, the number-order key 11c, attendant-call key 11d, the amount-confirmation key 11e, the order-confirmation key 11f, and the direct-keys 11g is operated.

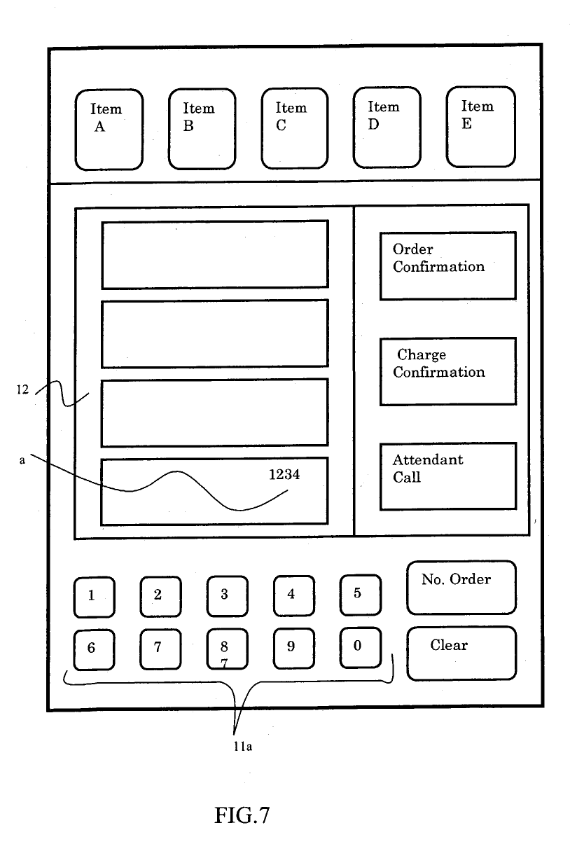

Upon key entry by one of the ten-keys 11a (Y in step S2), the ten-key entry is processed (step S8). In the ten-key processing, one of numerals of “0” through “9” corresponding to a key operated is memorized in the RAM 19, and the entered numeral a is displayed at a specified location on the LCD 12, as shown in FIG. 7.

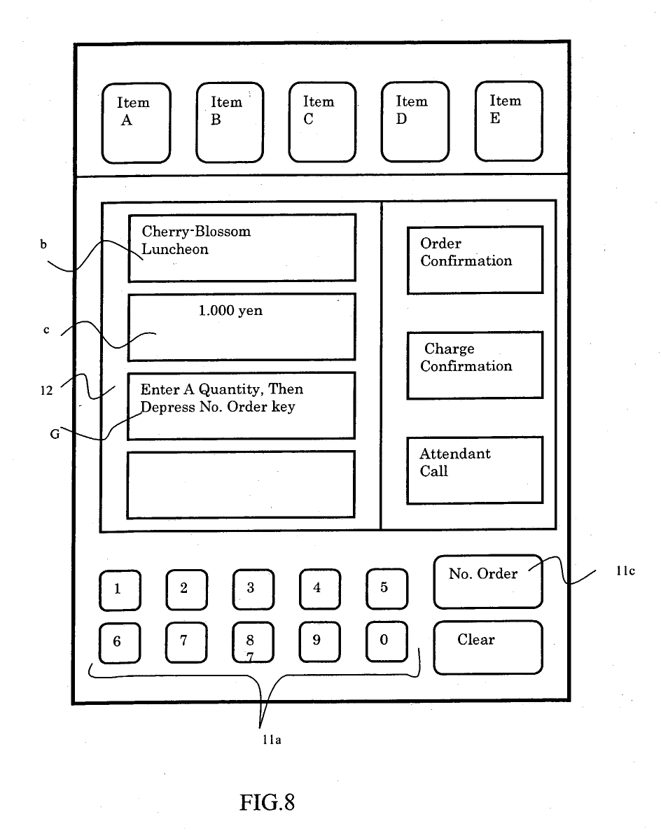

When entry has been made by the number-order key 11c (Y in step S3), judge is made whether an order confirmation window, which is to be discussed later, is currently displayed on the LCD 12 (step S9). If the order confirmation window is not shown on the LCD 12 (N in step S9), the order confirmation window is displayed on the LCD 12 (step S10). FIG. 8 shows one example of the order confirmation window displayed on the LCD 12. With the number-order key 11c having operated after entry of an item number by the ten-keys 11a, menu item name b and price c corresponding to the item number are extracted from the merchandise master file and displayed is displayed at a specified location, as shown in FIG. 8. Also displayed at a specified location in the order confirmation window in FIG. 8 is a guidance G for helping entering a quantity (for example, “Enter a quantity, then depress the number-order key”).

If the order confirmation window is already displayed on the LCD 12 (Y in step S9), a customer enters a quantity using the ten-keys 11a according to the guidance G, and then operates the number-order key 11c. Consequently, an order data is produced based on the item number and price, order transmission is processed to transmit the data to the control station 7 (step S11). Then, the order confirmation window displayed on the LCD 12 is cleared (step S12).

When entry has been made by the attendant-call key 11d (Y in step S4), an attendance-call processing is executed (step S13). In this attendant-call processing, for example, a predetermined signal is sent to the control station 7 so that a number of a table where the corresponding table-top ordering terminal 2 is placed is displayed in a display device (not shown) that is connected to the control station 7, and a buzzer (not shown) of the control station 7 goes off to inform the store attendant that he/she is being called by a customer.

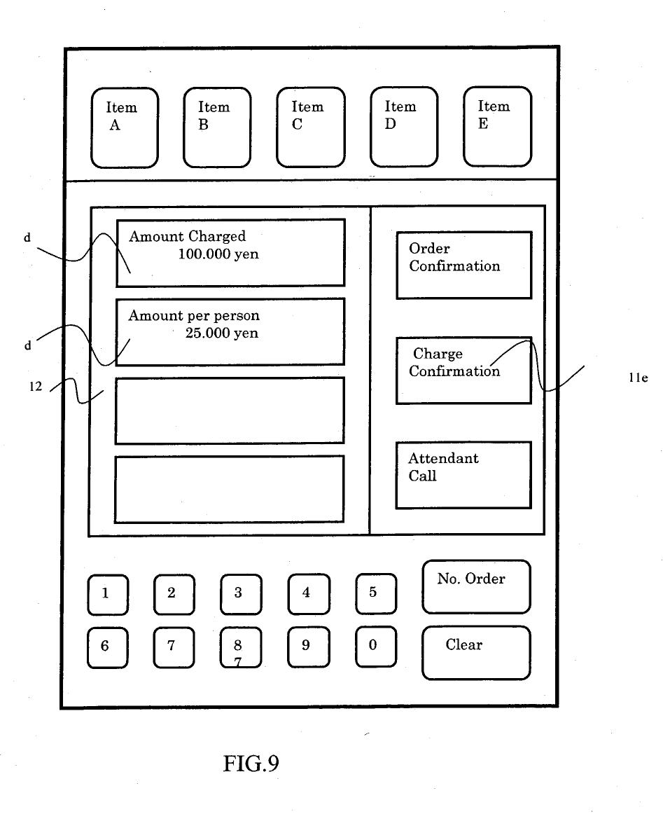

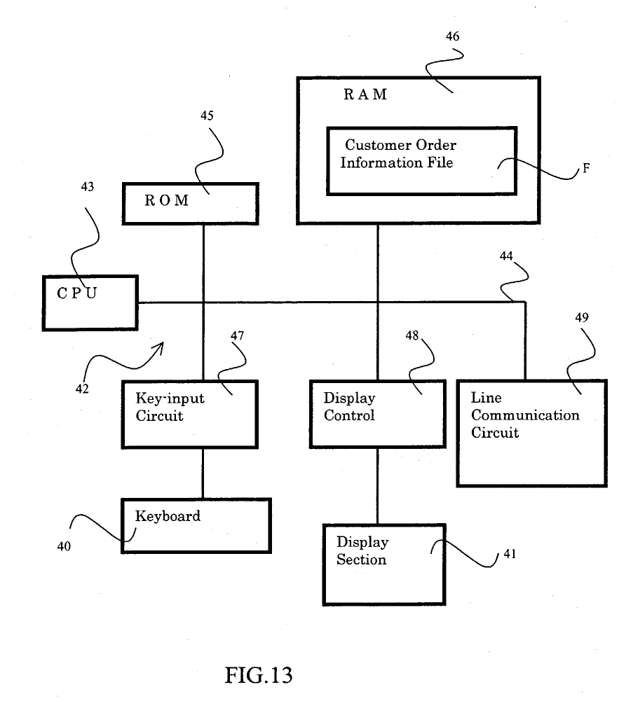

When entry has been made by the charge-confirmation key 11e (Y in step S5), the terminal obtains current-charge data (a total amount charged and an amount per person) from the control station 7, and displays the current-charge data d (a total amount charged and an amount per person) at a specified location on the LCD 12, as shown in FIG. 9 (step S14). This current-charge data (a total amount charged and an amount per person) is produced in the control station 7 based on various data memorized in a customer order information file F (see FIG. 13) of the control station 7, which is to be discussed later. After this data d is displayed for an approximately ten seconds, it is cleared (step 15).

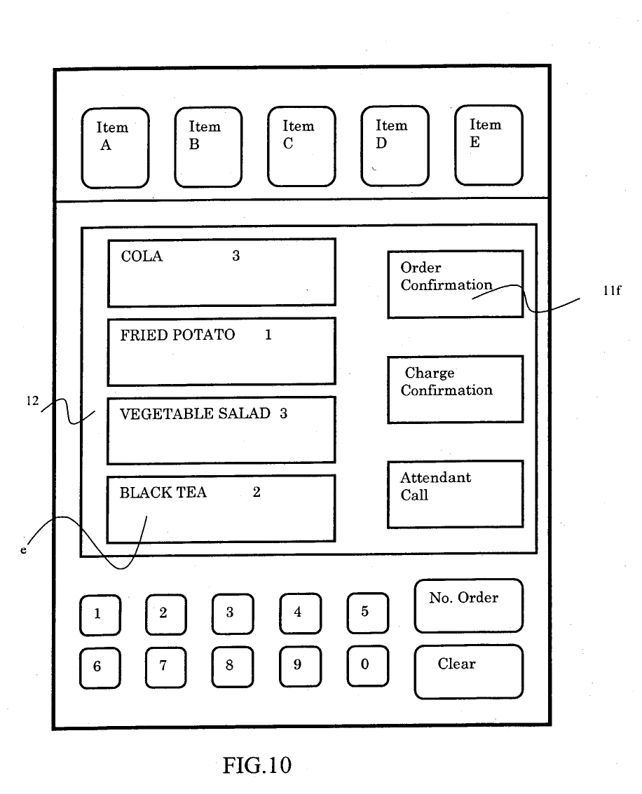

When entry has been made by the order-confirmation key 11f (Y in step S6), the terminal obtains order menu data containing current menu items that have been ordered by then from the control station 7, and displays the order menu data e (menu items and quantities) at a specified location on the LCD 12, as shown in FIG. 10 (step S16). This order menu data containing the current menu items is produced in the control station 7, which is to be discussed later, based on various data memorized in a customer order information file F (refer to FIG. 13). This order menu data e (menu items and quantities) is displayed for an approximately ten seconds and cleared (step S17). In this embodiment, if the number of the order menu items is more than four, the order menu data e (menu items and quantities) can be scrolled up to see the rest of the menu items by successively operating the order-confirmation key 11f.

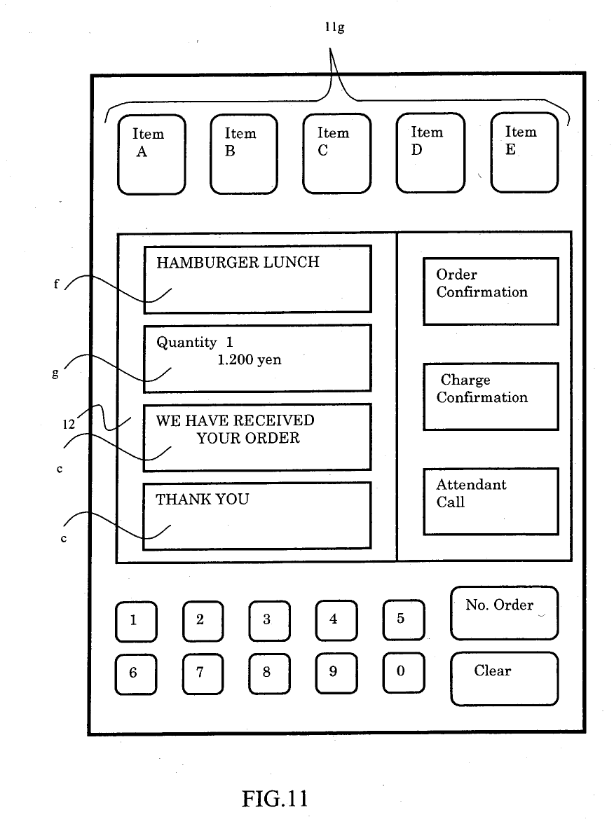

When entry has been made by the direct-key 11g (Y in step 7), the order transmission processing is executed (step 18). In this order transmission processing, a name of a menu item f and a price g of the menu item, which is information relating to an order of a menu item previously related to (preset to) an operated given key among the direct-key 11g, are extracted from the merchandise master file and displayed (refer to FIG. 11). Herein, order data is generated based on an item number and a quantity (this quantity is assigned to one in the order by the direct-key 11g) of the menu item previously related to the operated direct-key 11g, and transmitted to the control station 7. At this moment, a supplemental note c indicating that the order has been received (for example, “We have received your order. Thank you.”) is also displayed at a specified location of the display. After the menu item name(s) f, price(s) g, and supplemental note c are displayed for approximately ten seconds, they are cleared (step S19).

If the key entry is by other than the direct-key 11g (N in step S7), it is assumed to be by the clear key 11b. Accordingly, number(s) memorized in the RAM 19 are cleared. Then, the clear processing is carried out during which a number a displayed at a specified location on the LCD 12 as shown in FIG. 7 is cleared (step 20).

Now, structures of the handy terminal 3 and the control station 7 that constitute the order entry system 1 will be briefly described. Herein, description for the wireless communication system 4, the kitchen printer 5, and the POS terminal 6, which also constitute the order entry system 1 will be left out, since they are similar to conventional ones in their structures and functions.

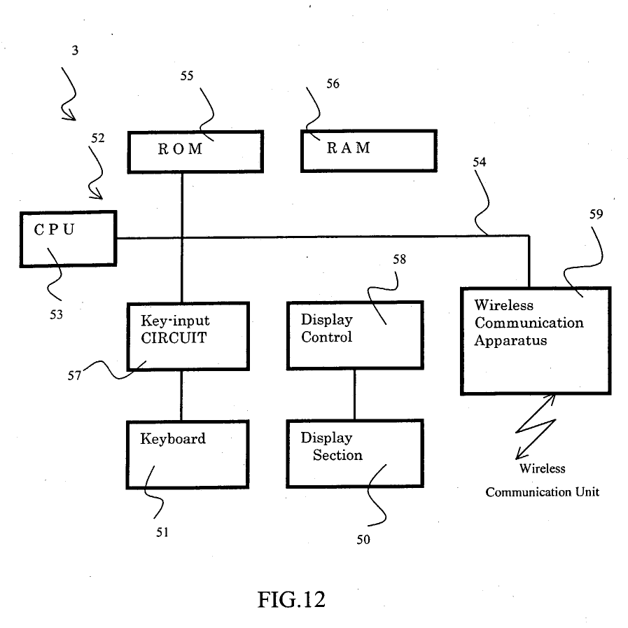

First, the handy terminal 3 will be explained. FIG. 12 is a block diagram displaying connections among the internal sections within the handy terminal 3. As shown in FIGS. 1 and 12, the handy terminal 3 is provided with a key board 51 in which various operation keys are arranged and a display section 50 that uses a LCD for displaying contents of orders and amounts. Although not specifically shown, the operation keys include ten-keys for entering numerals from “0” to “9,” menu keys for designating desired menu items, which have been previously related (preset) to respective menu items, and other keys.

As shown in FIG. 12, this handy terminal 3 contains a microcomputer 52, which controls each of internal sections. The microcomputer 52 is structured such that a ROM 55 that stores control programs for operating a CPU 53 and fixed data, and a RAM 56 that functions as a work-area memory where various data are freely rewritten are connected via a bus 54 to the CPU 53 that centrally controls each of the sections. Connected to this microcomputer 52 are a keyboard 51 through a key-input circuit 57 and a display section 50 through a display control 58. The handy terminal 3 is also provided with a wireless communication apparatus 59, being connected to the microcomputer 52 via the bus 54, for radio-communicating with the wireless communication system 4.

Next, the control station 7 will be explained. FIG. 13 is a block diagram indicating electrical connections among internal sections within the control station 7. As shown in FIGS. 1 and 13, this control station 7 is provided with a keyboard 40 in which various operation keys are arranged, and a display section 41 that uses a LCD. The operation keys arranged in the keyboard 40 include ten-keys for entering numerals of “0” to “9,” although they are not particularly shown.

As indicated in FIG. 13, the control station 7 is provided with a microcomputer 42, which controls each of the sections. The microcomputer 42 is structured such that a ROM 45 that stores control programs for operating a CPU 43 and fixed data, and a RAM 46 that functions as a work-area memory where various data are freely rewritten are connected via a bus 44 to the CPU 43 that centrally controls each of the sections. Connected to this microcomputer 42 are a keyboard 40 through a keyboard input circuit 47 and a display section 41 through a display controller 48. The control station 7 is also provided with a line communication apparatus 49, being connected to the microcomputer 42 via a bus 44, for communicating with each device via a communication line 8.

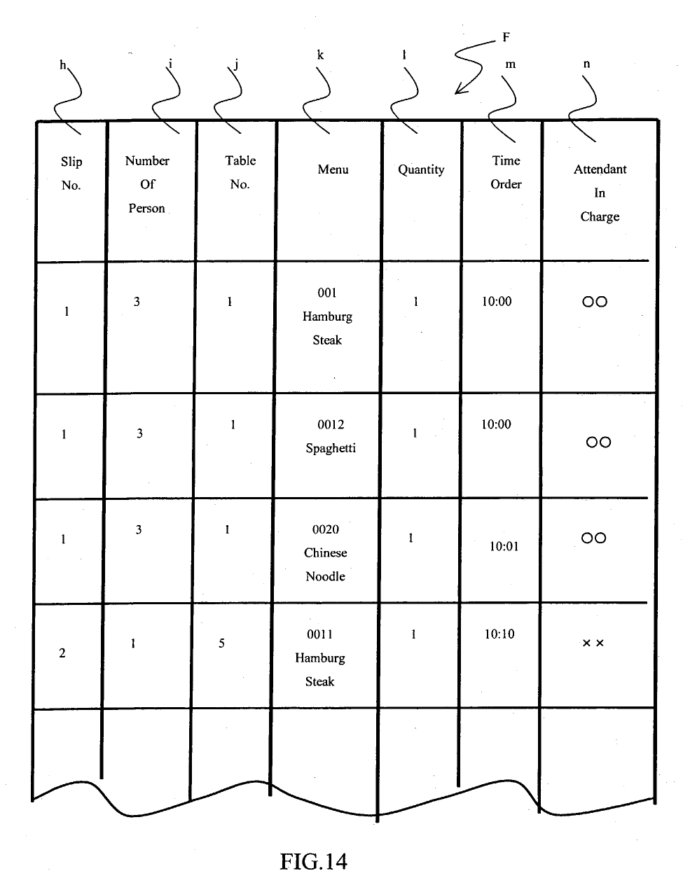

Also, in the RAM 46 within the control station 7, there is provided the customer order information file F for retaining the order data (order information). As shown in FIG. 14, in this the customer order information file F, for each of order slip numbers h, number of customers i, table number j, ordered menu item k, ordered quantity l, ordered time m, and name of a attendant-in-charge n, etc. are retained. Contents in this customer order information file F are maintained until all of accounting processing relating to an order slip of an applicable order slip number is completed in the POS terminal 6.

In the RAM 46 of the control station 7, a terminal designation table T

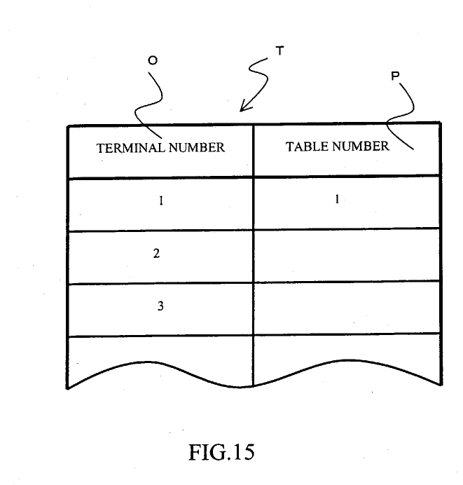

is provided. As shown in FIG. 15, This terminal designation table T specifies a relationship between a terminal number o that has previously been given for each of the table-top ordering terminal 2 and a table number p, also having previously given, of a table on which the table-top ordering terminal 2 is placed. In this embodiment, only table-top ordering terminals 2 whose terminal numbers that are specified on the terminal designation table T to relate to appropriate table numbers are validated for use. This will be discussed in detail later.

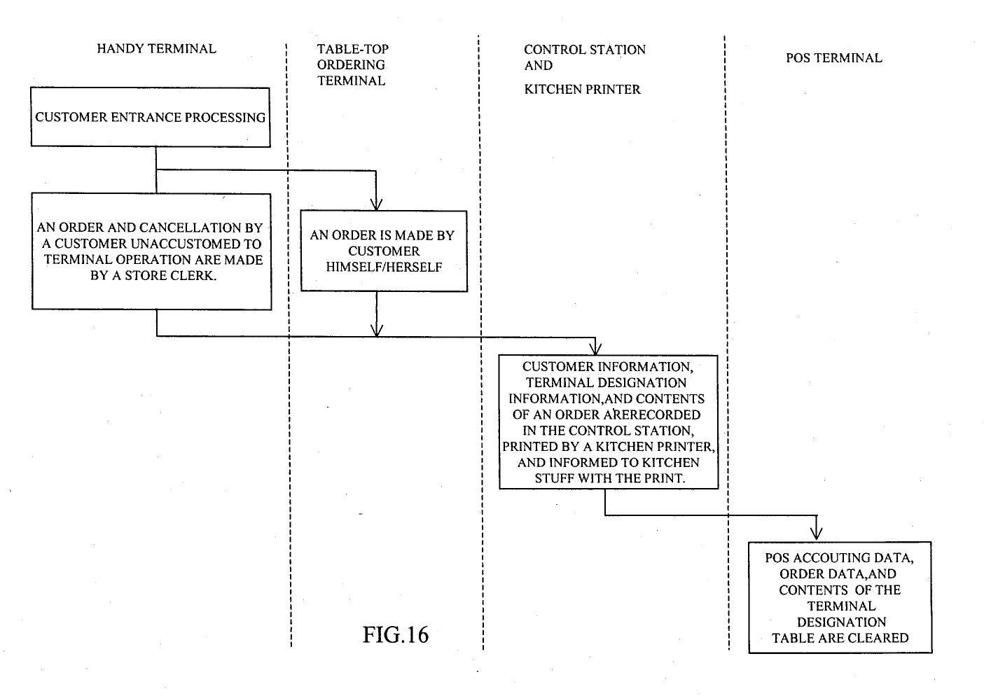

Next, operations of this order entry system 1 will be explained in reference to FIG. 16.

In an eating establishment using this order entry system 1, upon entry of a customer(s) a store attendant does the customer entrance processing by operating keys on the keyboard 51 of the handy terminal 3. In this processing, a store attendant first enters a predesignated number of a table to which he/she has guided, and then enters a terminal number, also pre-designated, of the table-top ordering terminal 2 that is provided in the table in order to relate the two numbers as terminal designation information on the terminal designation table T (if plural tables are to be occupied by a large number of customers, a single table-top ordering terminal 2 is designated). As mentioned above, only table-top ordering terminal 2, number of which is already related to a table on the terminal designation table T are available for use.

The customer information and the terminal designation information (table number(s) and terminal number(s)) as various information regarding customer's entrance, which are entered in the customer entrance processing, are then sent to the control station 7 through the wireless communication unit 4. In the control station 7, then, the terminal designation information (table number(s) and terminal number(s)) is memorized in the terminal designation table T, and the customer information is memorized in the customer order information file F as a part of order data (order information).

The customer entrance processing described in the above need not be limited to entry through the handy terminal 3, but the entry processing may be made from the kitchen printer 5, the POS terminal 6, the control station 7, etc.

After completion of the customer entrance processing by a store attendant, customer(s) guided to a given table places an order by himself/herself using the table-top ordering terminal 2 on the table that is enabled to operate, operating the operation keys 11 of the table-top ordering terminal 2, as described above.

The information relating to menu items (menu item names, prices and quantities attached to respective menu items) entered by operating the operation keys 11 of the table-top ordering terminal 2 becomes order data (order information) related to the terminal number of the aforementioned table-top ordering terminal 2.

For a customer who is not accustomed to operating such table-top ordering terminal 2, a store attendant, as in a conventional manner, enters an order, of which a customer verbally has informed looking at a handed menu table, by operating keys on the keyboard 51 of the handy terminal 3.

If an order that has been placed by a customer by himself/herself using the table-top ordering terminal 2 needs to be cancelled, a store attendant does the cancellation by operating keys on the keyboard 51 of the handy terminal 3.

That is, after completing the customer entrance processing that allows inputting various information relating to entrance of a customer into a store, the table-top ordering terminal 2 as an ordering terminal for customer's use transmits the order data (order information) to the control station 7. Because the customer entrance processing is done by a store attendant using the handy terminal 3 or others, a customer can use the table-top ordering terminal 2 without having to do the customer entrance processing.

The contents of the order inputted into the terminal in this manner are now transmitted to the control station 7 via the wireless communication system 4. The control station 7 stores the contents of the order in the customer order information file F as a part of order data (order information) relating to the customer information. The customer information and the contents of the order are also sent to the kitchen printer 5, which then produces a cooking instruction slip according to the contents of the order received. With this cooking instruction slip the contents of the ordered cooking is conveyed to a cook.

When an order is placed from the table-top order terminal 2, the control station 7 searches the terminal designation table T for a terminal number of an applicable table-top ordering terminal 2 that is contained in the order data (order information). An order placed from the applicable table-top ordering terminal 2 is to be accepted only if the terminal number being searched is currently related to an table number. The system is designed such that, if, for example, a group of customers are taken to three tables where each of the tables is provided with one table-top ordering terminal 2, only one of the table-top ordering terminal 2 is validated while the other two terminals are invalidated.

After all of cooking items that are ordered have been cooked, served, and finished to eat at the table(s), a customer gets his/her charge processed for accounting by the POS terminal 6. In this case, a customer goes to a cashier desk taking an accounting card that bears a table number, etc. A cashier, to whom the accounting card is presented, operates the POS terminal 6 to inquire the control station 7 for acquiring related accounting data. The cashier at the desk operates the POS terminal 6 then to get necessary accounting processed according to the obtained accounting data. Upon completion of the accounting processing, the order data (order information) and the contents on the terminal designation table T retained in the customer order information file F of the control station 7 are cleared.

In the order entry system 1 according to the present embodiment, a bill for processing accounting is not generated, but instead, an accounting card bearing table number, etc. is to be presented at a cashier desk. This is because, as mentioned earlier, current charge data (a charged amount and an amount per person) can be viewed by operating the charge-confirmation key 11e of the table-top ordering terminal 2, and current menu items that have been ordered by operating the order-confirmation key 11f thereof.

At this stage, one of the direct-keys 11g of five kinds, to each of which order information relating to a menu item displayed on the menu table M has previously been related, is operated in reference to the menu items displayed visually distinguishably on the menu table M, which is held in the slit S (formed as a groove) that constitutes the menu table holding section. Thus, if, for example, menu items that are frequently ordered or store-recommended are displayed on the menu table M, information relating to order(s) for menu item(s) that are frequently ordered or store-recommended can be transmitted to the control station 7 as an order management apparatus by simply operating one of the direct-keys 11g of five kinds that function as preset keys. Thus, miss-ordering in placing order(s) by a customer by himself/herself can be prevented by simple operation(s) of the direct-key 11g of five kinds. In addition, by making order information relating to each of menu items that are frequently ordered or store-recommended to associate with the respect direct-keys 11g, an effect of sales promotion can be expected.

What is claimed is:

1. An ordering terminal which sets up information relating to orders for all of menu items and, when information relating to an order for one of the menu items is inputted to the terminal, transmits information relating to the order to an order management apparatus, comprising:
a direct key that has previously been made to associate with information relating to the order for one of the menu items;
a display section for displaying information relating to the order for the menu item that is associated with said direct key, when said direct key is operated;
a transmitting section for transmitting the information relating to the order for the menu item for which said direct key is operated to the order management apparatus; and
a menu table holding section for holding a menu table that displays the menu item associated with said direct key.

2. An ordering terminal as described in claim 1, wherein said menu table holding section removable holds said menu table.

3. An ordering terminal as described in claim 1, wherein said direct key is positioned in close vicinity of the menu item displayed on the menu table while the menu table is held in the menu table holding section.

4. An ordering terminal as described in claim 2, wherein said direct key is positioned in close vicinity of the menu item displayed on the menu table while the menu table is held in the menu table holding section.

5. An ordering terminal as described in claim 1, wherein said display section clears contents of the display after lapse of a predetermined time from a point that the menu item associated with the direct key has been displayed.

6. An ordering terminal as described in claim 2, wherein said display section clears contents of the display after lapse of a predetermined time from a point that the menu item associated with the direct key has been displayed.

7. An ordering terminal as described in claim 3, wherein said display section clears contents of the display after lapse of a predetermined time from a point that the menu item associated with the direct key has been displayed.

8. An ordering terminal as described in claim 4, wherein said display section clears contents of the display after lapse of a predetermined time from a point that the menu item associated with the direct key has been displayed.

9. An ordering terminal as described in claim 1, wherein information of the menu item is cancelled by an apparatus other than the ordering terminal, after the order information has been transmitted.

10. An ordering terminal as described in claim 2, wherein information of the menu item is cancelled by an apparatus other than the ordering terminal, after the order information has been transmitted.

11. An ordering terminal as described in claim 3, wherein information of the menu item is cancelled by an apparatus other than the ordering terminal, after the order information has been transmitted.

12. An ordering terminal as described in claim 4, wherein information of the menu item is cancelled by an apparatus other than the ordering terminal, after the order information has been transmitted.

13. An ordering terminal as described in claim 5, wherein information of the menu item is cancelled by an apparatus other than the ordering terminal, after the order information has been transmitted.

14. An ordering terminal as described in claim 6, wherein information of the menu item is cancelled by an apparatus other than the ordering terminal, after the order information has been transmitted.

15. An ordering terminal as described in claim 7, wherein information of the menu item is cancelled by an apparatus other than the ordering terminal, after the order information has been transmitted.

16. An ordering terminal as described in claim 8, wherein information of the menu item is cancelled by an apparatus other than the ordering terminal, after the order information has been transmitted.

17. An order management system comprising:
an ordering terminal as described in any of claims 1 through 16; and
an order management apparatus that receives order information from said ordering terminal.

18. A method of ordering, comprising the steps of:
providing information by removable mounting a menu table that visually distinguishably displays menu items;
making information relating to an order for one of the menu items displayed on the menu table to associate with a direct key; and
transmitting to an order management system information relating to an order for a given one of the menu items by operating said direct key.
